(19) United States
(12) Patent Application Publication
(10) Pub. No.: US 2002/0030738 A1
(43) Pub. Date: Mar. 14, 2002

(54) Web based monitoring system

(76) Inventors: Joseph Daniel Moreinis, New York, NY (US); David Moreinis, New York, NY (US)

Correspondence Address: ST. ONGE STEWARD JOHNSTON & REENS, LLC, 986 BEDFORD STREET, STAMFORD, CT, 06905-5619, US

(21) Appl. No.: 09/872,967

(22) Filed: Jun. 1, 2001

Related U.S. Application Data
(60) Provisional application No. 60/209,017, filed on Jun. 1, 2000.

(51) Int. Cl. H04N 7/18; G06F 15/16

(52) U.S. Cl. 348/143; 709/206; 709/203

(57) ABSTRACT

The invention relates to a web based monitoring system and method including a computer, at least one camera in communication with the computer, software executing on the computer for transmitting data captured by the at least one camera to the computer, software executing on the computer for detecting an occurrence of an event based on the transmitted data, software executing on the computer for, upon the occurrence of the event, generating a notification, and software executing on the computer for transmitting the notification to a user.

### PRIORITY APPLICATION

This application claims priority benefits under 35 U.S.C. 119(e) of U.S. Provisional Patent Application No. 60/209,017, filed Jun. 1, 2000.

### FIELD OF THE INVENTION

The invention relates to a web based monitoring system and, more particularly, to a monitoring system that generates a notification to a user upon the occurrence of an event.

### BACKGROUND OF THE INVENTION

Video cameras are often used for surveillance. Generally, stores, banks, and other businesses desiring to videotape, record, or otherwise monitor the building, employees, or customers may install cameras, whether hidden or in plain view, in selected areas of the building and, from a location accessible to the cameras, view what is captured by the cameras. This known surveillance system is beneficial because a user can be in one location, yet theoretically view the entire building. A disadvantage of the system is that the images captured by the cameras, if not recorded, generally require active monitoring by a user. If there is no user who is actively watching the cameras and the images are sent to the user's location, any suspicious or undesired activity would go unnoticed.

A way to overcome this disadvantage, but which presents another disadvantage, is to either have a user continuously monitoring the cameras for such activities or to have the cameras continuously recording what is being captured. However, having a user continuously monitoring the cameras or continuously recording what is captured by the cameras would require a user to watch what generally are lengthy footages, much of it likely being uneventful and monotonous to the user.

Besides surveillance, other current uses of video cameras may include a parent desiring to monitor their baby or babysitter's activities. The parent may use a video camera to record activities occurring in the home while he/she is away. A disadvantage of using a video camera is that remote control is limited to the distance the parent is from the camera. A further disadvantage of the video camera is that the camera must be continuously recording in order for the parent to later view the activities. Also, the amount the parent, who must wait to come home to view the recorded tape, can record typically depends on the length of the recording tape. In addition, should an emergency requiring immediate attention be recorded, the parent may not discover the nature of the emergency until a later time. Moreover, a plurality of cameras require a plurality of recording tapes, each needing to be continuously recording for later viewing. Therefore, a parent wishing to watch his/her child, particularly when using numerous cameras throughout the home, may prove unwieldy to monitor.

A system for monitoring a home for intruders or vandals operates in a similar fashion to the parent wishing to monitor his/her child or nanny. Generally, numerous cameras are needed to sufficiently monitor the entire home, especially areas of the home having jewelry, rare coins, paintings, cash, or other valuables that typically may cause a homeowner to position a camera nearby.

What is desired, therefore, is a system that captures images and/or audio from remotely located cameras. What is also desired is a system that sends the captured images and/or audio to the user location as they are captured. What is further desired is a system that captures images and/or audio without requiring the user to actively monitor the captured images or audio or requiring the user to later struggle through voluminous amounts of recordings.

### SUMMARY OF THE INVENTION

Accordingly, it is an object of the invention to provide a system that automatically detects for an occurrence of an event based upon data captured and transmitted from a camera.

Another object of the invention is to provide a system that, upon the occurrence of the event, automatically generates a notification to be transmitted to a user terminal.

Yet another object of the invention is to provide a system that automatically transmits the notification to the user.

A further object of the invention is to provide a system that transmits the data to the user in real time.

These and other objects of the invention ar e achieved by a system comprising a computer, at least one camera in communication with the computer, software executing on the computer for transmitting data captured by the at least one camera to the computer, software executing on the computer for detecting an occurrence of an event based on the transmitted data, software executing on the computer for, upon the occurrence of the event, generating a notification, and software executing on the computer for transmitting the notification to a user.

The system may further include software executing on the computer for transmitting data in real time. In addition, the system may also include a user terminal for receiving the transmitted data.

The system may further include software executing on the computer for recording at least one pictorial representation of the transmitted data, such as a snap shot image or footage of tape.

The event to be detected may be a visual movement, an audible sound or voice, or a combination of the above. To facilitate detection of the occurrence of the event, the system may further include sound recognition and motion detection software.

Upon detection, the system automatically generates notification to be sent to the user. The notification is any type of signal alerting the user as to the occurrence of the event, such as an email, phone call, alarm, pager signal, or beeper signal.

The system may further include a database in communication with the computer for storing the notification, event, and data. The database, although useful, is not essential for the system to function properly.

In another aspect, the invention includes a method for a web based monitoring system comprising the steps of providing a computer, providing at least one camera in communication with the computer, transmitting data captured by the at least one camera to the computer, analyzing the transmitted data to detect for an occurrence of an event, generating a notification upon the occurrence of the event, and transmitting the notification to a user.

The method may further include the step of retrieving, transmitting, and analyzing the data in real time.

The method may further include the step of automatically generating the notification upon the occurrence of the event and automatically transmitting the notification to the user.

The invention and its particular features and advantages will become more apparent from the following detailed description considered with reference to the accompanying drawings.

### BRIEF DESCRIPTION OF THE DRAWINGS

FIG. 1 depicts the system in accordance with the invention.

FIG. 2 depicts the method in accordance with the invention.

### DETAILED DESCRIPTION OF THE DRAWINGS

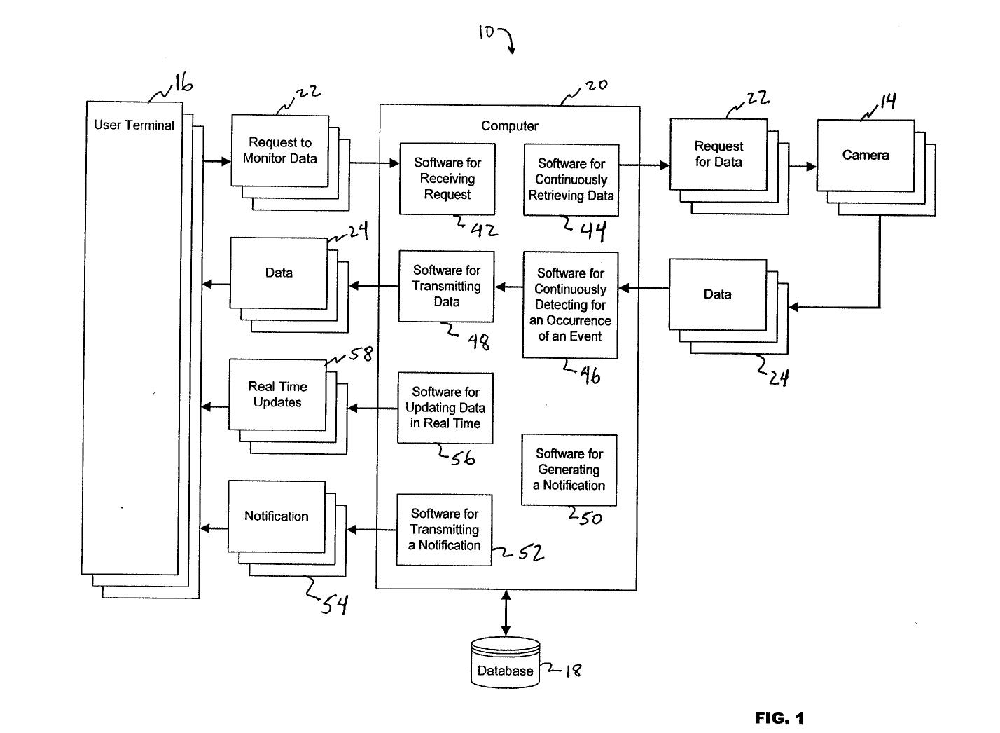

FIG. 1 depicts the system in accordance with the invention. System 1 0 is a web based monitoring system that generates a notification upon an occurrence of an event. System 10 permits passive, as opposed to active, monitoring, thereby permitting a user to monitor activities captured by camera 14 without being required to continuously watch the images and/or listen to the audio transmitted by camera 14.

The invention advantageously reduces the amount of time a user, who uses conventional systems, watches monotonous reels of prior camera recordings or from sitting in a user location viewing multiple monitors that are receiving data transmitted from multiple cameras 14.

System 10 comprises camera 14, computer 20, and user terminal 16. Optionally, system 10 may further comprise database 18 for storing data transmitted by camera 14, notification 54 generated by computer 20, or both.

System 10 operates upon a user transmitting a request 26 to monitor data. Request 26 is received by software 42 for receiving request 22. Subsequently, software 44 for continuously retrieving data transmits request 22 to camera 14. Camera 14 then captures and sends 24 data, visual and/or audio, back to computer 20. Software 46 for continuously detecting for an occurrence of an event continuously analyzes the transmitted data 24 from camera 14.

The event that is being detected by software 46 is an event predetermined and specified to computer 20. The event may be specified prior to or during operation of system 10. Typical events include a cry of a baby, where a parent using system 10 desires to monitor his/her child. Breaking glass or movement within the home may be specified as another event, where a homeowner desires to monitor his/her home. The event is any visual and/or audio sound that is capable of being detected by software 46 for continuously detecting for an occurrence of the event. To facilitate identifying the specified event, system 10 may further include sound or motion sensing software.

Whether an event occurs or not, software 48 for transmitting data continuously transmits data 24 to user terminal 16. Upon the event occurring, software 50 for generating a notification to the user that the event occurred generates and transmits, via software 52 for transmitting a notification, notification 54 to user terminal 16. Because system 10 is continuously analyzing data 24 as it is received from camera 14 and system 10 automatically generates and transmits notification 54 to user terminal 16, a user is not required to actively monitor the received data from computer 20, which was typically required when using conventional systems. System 10, therefore, permits passive, yet effective, monitoring.

Computer 20 includes a server, single computer, plurality of computers, network of computers, or any device for executing software. Computer 20 continuously retrieves and transmits data 24 to user terminal 16. Although not required for proper operation of system 10, software 56 for updating data, visual and/or audio, in real time transmits real time updates 58 of the transmitted data to user terminal 16. This permits a user to receive data 24, visual and/or audio, in real time and is beneficial because the user is receiving data as it is captured by camera 14. This is particularly beneficial when time is of the essence, as in detecting for an emergency or urgent event.

In certain embodiments, although not required for proper operation of system 10, upon the occurrence of the event, computer 20 may automatically begin recording the transmitted data 24 to provide a recording or memorialized documentation of the event. This includes recorded footage and snap shot images as well as recorded audio. These recordings may be stored on database 18. In other embodiments, computer 20 is already recording data 24 being transmitted from camera 14 and, hence, a recording or memorialized documentation of the event is already being generated.

Camera 14 includes any known or novel device for capturing visual and/or audio data and transmitting it to computer 20. In certain embodiments, camera 14 is wall mounted for capturing images. In other embodiments, camera 14 is hidden, small, and captures audio and visual data. Camera 14 may also be wireless or hard wired. The limitations or types of cameras are not germane to the invention. All that is required is that camera 14 be able to receive commands 22 from computer 20 to transmit data 24, either visual and/or audio, back to computer 20. Multiple, or unlimited numbers of, cameras 14 may also be used in system 10 for monitoring numerous areas, such as positions around a house, building, or parking lot.

Sound recognition software is known or novel software that distinguishes between familiar and unfamiliar sounds. Hence, sound recognition software can tell the difference between a particular person's voice and street or background noise. In certain embodiments, sound recognition software measures frequency or voice treble/bass to identify a particular person, such as an infant who is being monitored. In other embodiments, sound recognition software measures amplitude or sound duration of a speaker's voice to differentiate familiar voice from noise, such as noise from inanimate objects being dropped. In certain embodiments, sound recognition software includes voice recognition software.

Motion sensing software is known or novel software that discern visual motion or movement. In certain embodiments, infrared beams or motion sensors are used with software to indicate that a visual event has occurred.

It should be noted that sound recognition and motion sensing software have adjustable sensitivities so as not to generate false alarms. It should also be noted that known sound recognition and motion sensing software are to be used as a part of system 10, together with software 46 for continuously detecting for an occurrence of an event, software 50 for generating notification 54, and software 52 for transmitting notification 54.

Notification 54 is any signal transmitted by computer 20 to user terminal 16 to alert the user of the occurrence of an event. Notification 54 includes an email, alarm, pager message, beeper message, or phone call sent to the user by computer 20.

User terminal 16 is for receiving notification 54 and is located in an area accessible to the user. In certain embodiments, user terminal 16 is a computer. In other certain embodiments, user terminal 16 is a phone. User terminal 16 may also be an email address, beeper, pager, wireless device such as an electronic pocket-sized organizer, or any device for receiving notification 54. In certain embodiments, user terminal 16 is located remotely from computer 20. User terminal 16 and/or computer 20 may be an Internet location, whereby a user may operate system 10, including issuing request 22 and receiving data 24, from an Internet location. In other certain embodiments, user terminal 16 is located in close proximity and may even connected to, such as being networked with, computer 20. In still other embodiments, user terminal 16 and computer 20 are the same. All that is required is that user terminal 16 be capable of receiving notification 54 transmitted from computer 20. User terminal 16 may further be a wireless connection to computer 20.

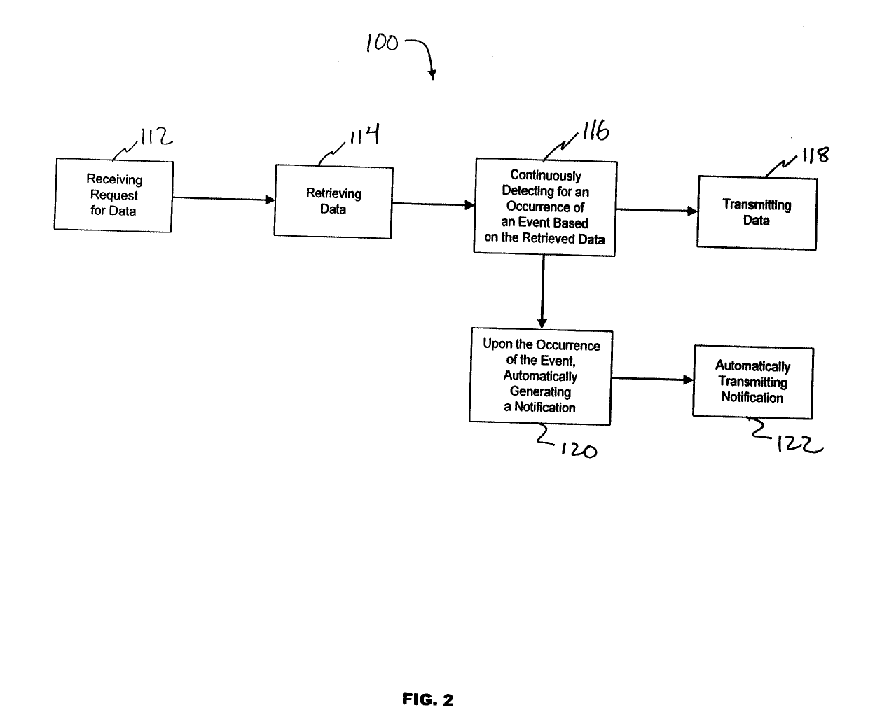

FIG. 2 depicts the method in accordance with the invention. Method 110 comprises the steps of receiving 112 a user request to monitor data, retrieving 114 the requested data, continuously detecting 116 for an occurrence of an event based on the retrieved data, transmitting 118 the data to a user terminal, upon the occurrence of the event, automatically generating 120 a notification, and automatically transmitting 122 the notification to the user terminal.

Method 100 begins when a user operating a user terminal sends a request to monitor data. Method thereafter includes the step of receiving 112 the user request and subsequently retrieving 114 the requested data, whether visual and/or audio, from camera 14. Camera 14 transmits the requested data back to computer 20.

Upon receipt of the data, method 100 includes the stop of continuously detecting 116 for an occurrence of an event based on the retrieved data. The event, as described above, is predetermined by the user and includes any visual and/or audio happening. Method 100 automatically analyzes data received from the camera and, upon the occurrence of the specified event, causes method 100 to automatically generate 120 a notification to alert the user as to the occurrence of the event.

Upon automatically generating 120 the notification, method 100 automatically transmits 122 the notification to the user terminal. Notification is any signal that alerts a user as to the occurrence of the event, including an email, pager message, beeper message, phone call, or any transmitted signal.

Whether the event has occurred or not, method 100 includes the step for automatically transmitting 118 the requested data to the user terminal. Data is transmitted to the user terminal on a continuous basis, as requested by the user. In certain embodiments, data is transmitted on a real time basis.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A monitoring system, comprising:
a computer;
at least one camera in communication with said computer;
software executing on said computer for transmitting data captured by said at least one camera to said computer;
software executing on said computer for detecting an occurrence of an event based on the transmitted data,
software executing on said computer for, upon the occurrence of the event, generating a notification; and
software executing on said computer for transmitting the notification to a user.

2. The system according to claim 1, further comprising software executing on said computer for transmitting data in real time.

3. The system according to claim 1, further comprising a user terminal for receiving said transmitted data.

4. The system according to claim 1, further comprising software for recording at least one pictorial representation of the transmitted data.

5. The system according to claim 1, further comprising sound recognition software.

6. The system according to claim 1, further comprising motion detection software.

7. The system according to claim 1, wherein the event is an audible sound.

8. The system according to claim 1, wherein the event is a visual movement.

9. The system according to claim 1, wherein the notification is an email.

10. The system according to claim 1, wherein the notification is a phone call.

11. The system according to claim 1, wherein the notification is a pager signal.

12. The system according to claim 1, further comprising a database in communication with said computer and wherein the notification, event, and data are stored on said database.

13. The system according to claim 1, wherein said at least one camera is remotely located from said computer.

14. The system according to claim 1, further comprising software for, upon the occurrence of the event, automatically generating the notification.

15. The system according to claim 1, further comprising software for automatically transmitting the notification to the user.

16. A monitoring system, comprising:
a computer;
at least one camera in communication with said computer;
software executing on said computer for transmitting data captured by said at least one camera to said computer;
software executing on said computer for detecting an occurrence of an event based on the transmitted data;
wherein the event is selected from the group consisting of an audible sound, a visual movement, and combinations thereof;
software executing on said computer for, upon the occurrence of the event, generating a notification;
software executing on said computer for transmitting the notification to a user; and
wherein the notification is selected from the group consisting of an email, a phone call, a beeper message, a pager message, an alarm, and combinations thereof.

17. A method for monitoring, comprising:
providing a computer;
providing at least one camera in communication with said computer;
transmitting data captured by said at least one camera to said computer;
analyzing the transmitted data to detect for an occurrence of an event;
generating a notification upon the occurrence of the event; and
transmitting the notification to a user.

18. The method according to claim 17, further comprising the step of transmitting data in real time

19. The method according to claim 17, further comprising the step of automatically generating the notification upon the occurrence of the event.

20. The method according to claim 17, further comprising the step of automatically transmitting the notification to the user.
